(19) United States
(12) Patent Application Publication
(10) Pub. No.: US 2026/0270524 A1
(43) Pub. Date: Sep. 10, 2026

(54) SYSTEM AND METHOD FOR LIVE STREAMING

(71) Applicant: 17LIVE Japan Inc., Tokyo (JP)

(72) Inventors: Yen-Hsuan LEE, Taipei City (TW); Yung-Chi HSU, Taipei City (TW); Yu-Chuan CHANG, Taipei City (TW); Yu-Wen HUANG, Taipei City (TW); Hao-Jung LO, Taipei City (TW); Yun-Chieh WANG, Taipei City (TW); Shih-Bo LIN, Taipei City (TW)

(21) Appl. No.: 19/561,088

(22) Filed: Mar. 9, 2026

(30) Foreign Application Priority Data
Mar. 10, 2025 (JP) 2025-037018
Mar. 26, 2025 (JP) 2025-052677
Jun. 26, 2025 (JP) 2025-107804

(51) Int. Cl. H04N 21/482

(52) U.S. Cl. CPC H04N 21/4826

(57) ABSTRACT

The present disclosure relates to a system and a method for live streaming. The method includes: obtaining first interaction data of a first live stream room; and dynamically determining a first size of a first thumbnail of the first live stream room according to the first interaction data; and displaying the first thumbnail on a recommendation page in accordance with the first size.

### CROSS-REFERENCE TO RELATED APPLICATIONS

This application is based on and claims the benefit of priority from Japanese Patent Application Serial No. 2025-037018 (filed on Mar. 10, 2025), No. 2025-052677 (filed on Mar. 26, 2025), and No. 2025-107804 (filed on Jun. 26, 2025), the contents of which are hereby incorporated by reference in their entirety.

### BACKGROUND OF THE DISCLOSURE

### Technical Field

The present disclosure relates to streaming and, more particularly, to live streaming.

Description of the Related Art

Real time interaction on the Internet, such as live streaming service, has become popular in our daily life. There are various platforms or providers providing the service of live streaming, and the competition is fierce. It is important for a platform to provide its users their desired services.

US patent application publication US20240146979A1 discloses a method for recommending live streams.

US patent application publication US20240305836A1 discloses a method for live streaming.

### SUMMARY OF THE INVENTION

A method according to one embodiment of the present disclosure is a method for live streaming being executed by one or a plurality of computers, and includes: obtaining first interaction data of a first live stream room; and dynamically determining a first size of a first thumbnail of the first live stream room according to the first interaction data; and displaying the first thumbnail on a recommendation page in accordance with the first size.

A system according to one embodiment of the present disclosure is a system for live streaming that includes one or a plurality of processors, and the one or plurality of processors execute a machine-readable instruction to perform: obtaining first interaction data of a first live stream room; and dynamically determining a first size of a first thumbnail of the first live stream room according to the first interaction data; and displaying the first thumbnail on a recommendation page in accordance with the first size.

A non-transitory computer-readable medium including a program for live streaming, wherein the program causes one or a plurality of computers to execute: obtaining first interaction data of a first live stream room; and dynamically determining a first size of a first thumbnail of the first live stream room according to the first interaction data; and displaying the first thumbnail on a recommendation page in accordance with the first size.

A method according to one embodiment of the present disclosure is a method for live streaming being executed by one or a plurality of computers, and includes: obtaining a gift signal sent from a first viewer in a live stream room; and displaying a gift effect corresponding to the gift signal to the first viewer and a distributor of the live stream room in the live stream room, wherein the gift effect is invisible to other viewers or distributors in the live stream room.

A method according to one embodiment of the present disclosure is a method for live streaming being executed by one or a plurality of computers, and includes: obtaining a gift signal sent from a viewer to a distributor in a live stream room; displaying a preview of a gift effect corresponding to the gift signal to the distributor; obtaining a selection result with respect to the preview from the distributor; and determining whether or not to display the gift effect to other viewers in the live stream room according to the selection result.

A system according to one embodiment of the present disclosure is a system for live streaming that includes one or a plurality of processors, and the one or plurality of processors execute a machine-readable instruction to perform: obtaining a gift signal sent from a first viewer in a live stream room; and displaying a gift effect corresponding to the gift signal to the first viewer and a distributor of the live stream room in the live stream room, wherein the gift effect is invisible to other viewers or distributors in the live stream room.

A method according to one embodiment of the present disclosure is a method for live streaming being executed by one or a plurality of computers, and includes: determining a topic in a live stream to have met a generation condition; inputting the topic as a prompt into a generative AI model to generate an effect; and displaying the effect in the live stream.

A system according to one embodiment of the present disclosure is a system for live streaming that includes one or a plurality of processors, and the one or plurality of processors execute a machine-readable instruction to perform: determining a topic in a live stream to have met a generation condition; inputting the topic as a prompt into a generative AI model to generate an effect; and displaying the effect in the live stream.

A non-transitory computer-readable medium including a program for live streaming, wherein the program causes one or a plurality of computers to execute: determining a topic in a live stream to have met a generation condition; inputting the topic as a prompt into a generative AI model to generate an effect; and displaying the effect in the live stream.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server 10 of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 is a data structure diagram showing an example of the interaction DB 330.

FIG. 8 shows an example of a recommendation page according to some embodiments of the present disclosure.

FIG. 9 is a data structure diagram showing an example of the thumbnail DB 332.

FIG. 10 shows an example of displaying a recommendation page in accordance with some embodiments of the present disclosure.

FIG. 11 shows an example of adjusting the thumbnail size in a stream room in accordance with some embodiments of the present disclosure.

FIG. 12 is a data structure diagram showing an example of the gift DB 314.

FIG. 13 shows an exemplary flow according to some embodiments of the present disclosure.

FIG. 14 is a block diagram showing an example of a hardware configuration of the information processing device according to some embodiments of the present disclosure.

FIG. 15 shows a block diagram illustrating functions and configuration of the server 10 of FIG. 1 according to some embodiments of the present disclosure.

FIG. 16 is a data structure diagram showing an example of the gift type DB 330a.

FIG. 17 is a data structure diagram showing an example of the gift record DB 332a.

FIG. 18 shows an example of live streaming in accordance with some embodiments of the present disclosure.

FIG. 19 shows an example of live streaming in accordance with some embodiments of the present disclosure.

FIG. 20 shows an example of live streaming in accordance with some embodiments of the present disclosure.

FIG. 21 shows an example of live streaming in accordance with some embodiments of the present disclosure.

FIG. 22 shows an exemplary flow according to some embodiments of the present disclosure.

FIG. 23 shows an example of live streaming in accordance with some embodiments of the present disclosure.

FIG. 24 shows a block diagram illustrating functions and configuration of the server 10 of FIG. 1 according to some embodiments of the present disclosure.

FIG. 25 is a data structure diagram showing an example of the condition DB 330b.

FIG. 26 is a data structure diagram showing an example of the effect DB 332b.

FIG. 27 shows an example of live streaming in accordance with some embodiments of the present disclosure.

FIG. 28 shows an example of live streaming in accordance with some embodiments of the present disclosure.

FIG. 29 shows an example of live streaming in accordance with some embodiments of the present disclosure.

FIG. 30 is a data structure diagram showing another example of the effect DB 332b.

FIG. 31 shows an example of live streaming in accordance with some embodiments of the present disclosure.

FIG. 32 shows an exemplary flow according to some embodiments of the present disclosure.

FIG. 33 shows an example of live streaming in accordance with some embodiments of the present disclosure.

FIG. 34 shows an example of live streaming in accordance with some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

Engaging users and fostering interactions between them, such as between content distributors and viewers, is critical to the success of streaming platforms. Features that enhance user engagement not only enrich the viewing experience but also contribute to the platform's overall growth and retention. Therefore, there is a need for streaming platforms to implement innovative solutions that strengthen the connection between users. How to recommend the most interactive streams to viewers is also important for the streaming platform.

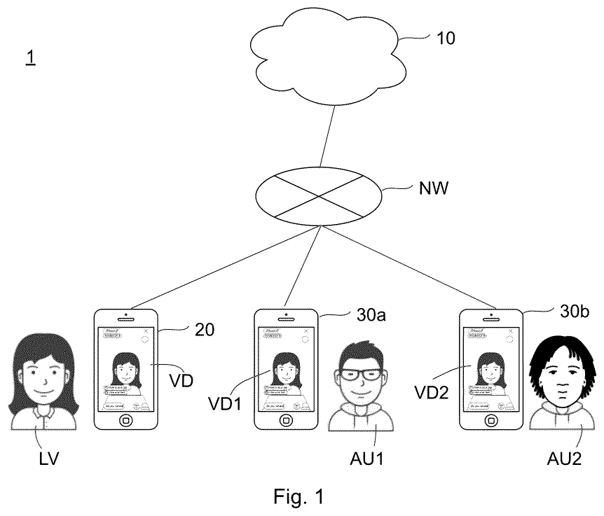

FIG. 1 shows a schematic configuration of a live streaming system 1 according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b. . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

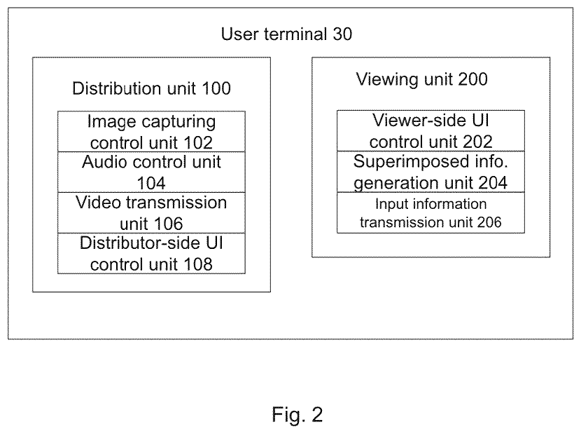

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distributor-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distributor-side UI control unit 108 controls an UI (user interface) for the distributor. The distributor-side UI control unit 108 may be connected to a display (not shown in FIG. 2), and displays a video on the display by reproducing the video data that is to be transmitted by the video transmission unit 106. The distributor-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

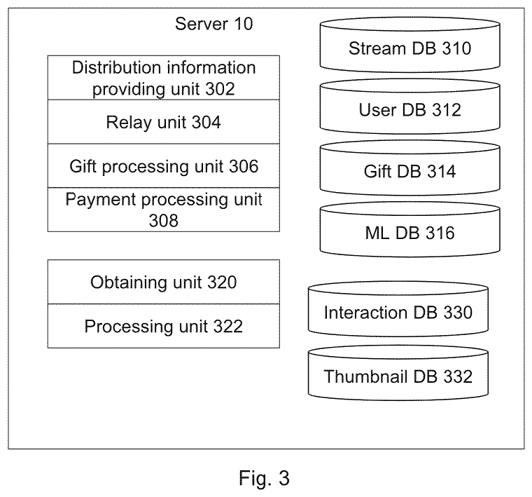

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, a ML DB 316, an obtaining unit 320, a processing unit 322, an interaction DB 330, and a thumbnail DB 332.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

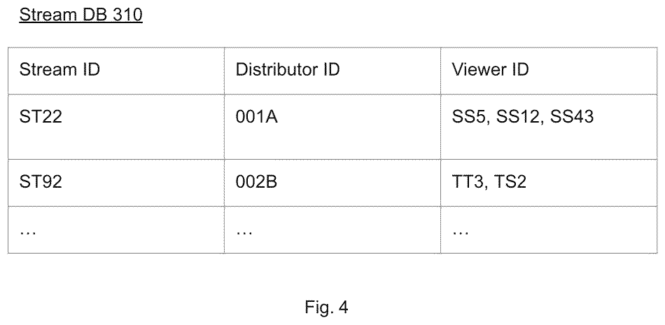

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

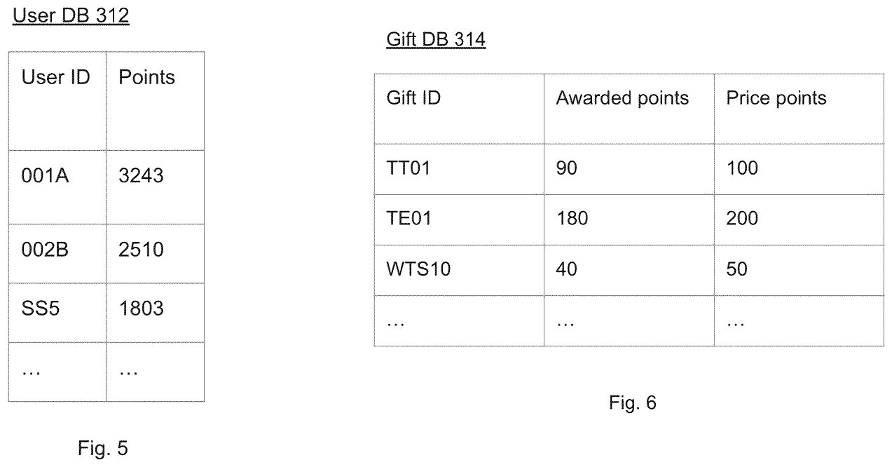

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

The ML DB 316 may store various machine learning models and/or AI models. For example, one or more large language models (LLM) or generative AI models may be included in the ML DB 316. Video/image/audio recognition models may be included in the ML DB 316. In some embodiments, the ML DB 316 may be implemented outside server 10.

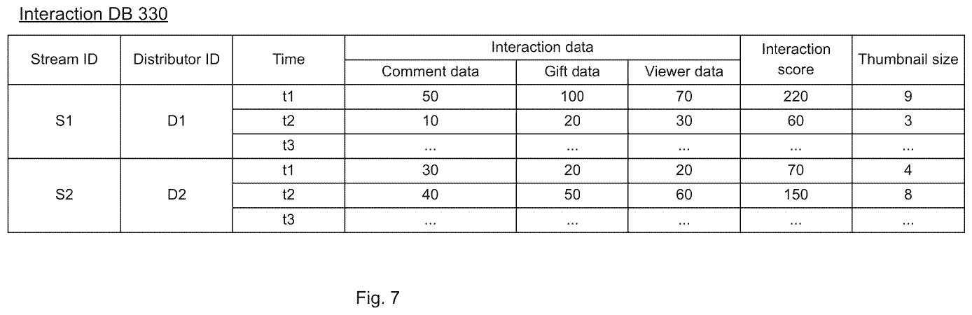

FIG. 7 is a data structure diagram showing an example of the interaction DB 330. The interaction DB 330 stores the stream ID, the distributor ID, the time, the interaction data, the interaction score, and the thumbnail size, in association with each other. The interaction data may include comment data, gift data, and viewer data.

The stream ID identifies a stream room. The distributor ID identifies the distributor of the stream room. The time identifies the timing or time span. The comment data could include comment number, comment frequency and/or comment density, or any calculated result (such as normalization) based on the above data. The gift data could include gift number, gift amount, gift frequency and/or gift density, or any calculated result (such as normalization) based on the above data. The viewer data could include viewer number or change rate (such as increase rate) of viewer number. The viewer data could include retention data of viewers. The above data could be obtained and stored by obtaining unit 320, for example.

The interaction score is calculated from the interaction data. In this example, it is the sum of respective interaction data. The calculation could be performed by the processing unit 322, for example. The interaction score indicates how interactive/engaged the viewers (or the distributor) are in the stream room. A higher interaction score may indicate the stream room is in a more interactive status. A less interaction score may indicate the stream room is in a less interactive status.

The thumbnail size indicates/controls the size of the stream room in a recommendation page on the streaming platform. The thumbnail size could be determined by the processing unit 322 according to the interaction score. For example, a greater interaction score may result in a greater thumbnail size. A less interaction score may result in a smaller thumbnail size.

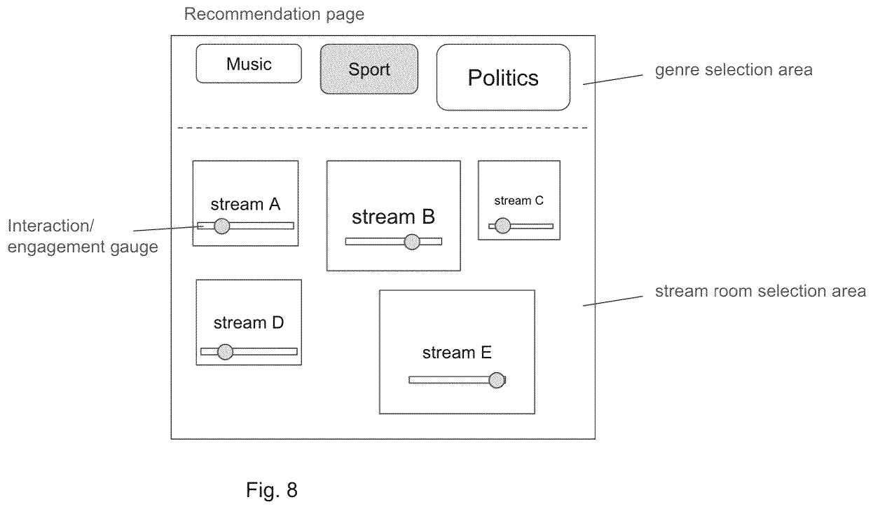

FIG. 8 shows an example of a recommendation page according to some embodiments of the present disclosure.

The recommendation page is for a viewer to choose which stream room to join. As shown, there is a genre/category selection area and a stream room selection area. The viewer may select a genre he/she is interested in, and then choose a specific stream room in that genre. When a genre is selected, the stream room selection area displays the corresponding stream rooms, specifically the thumbnails of those stream rooms, for the viewer to choose.

Different stream rooms in the stream room selection area have different thumbnail sizes, according to their respective interaction/engagement gauge. The interaction gauge could dynamically reflect the interaction score of the stream room. The interaction score changes according to the real time interaction data in the stream room in a real time manner. At a certain timing, a stream room with a greater interaction score would have a bigger thumbnail, and a stream room with a less interaction score would have a smaller thumbnail. Therefore, those thumbnails shown to a viewer may keep changing size in a dynamic manner. The size adjustment could be performed by the processing unit 322 by referring to the interaction DB 330.

As shown, tags of different genres also have different sizes. The size of a genre tag could be dynamically determined by the processing unit 322 by referring to the real time interaction scores of the steam rooms under that genre. For example, a real time average of the interaction scores of the steam rooms under a genre could be used to determine the real time size of the genre tag. As a result, if a genre has stream rooms that are more interactive at the timing of displaying the recommendation page to a viewer, the tag of the genre could be bigger. For example, when an election is approaching, the tag “politics” may contain more stream rooms wherein the users (distributors and viewers) are more interactive or engaged. The mechanism can help a viewer select the most vibrant genre or stream room, and can have a better chance of keeping the viewer in the stream room longer.

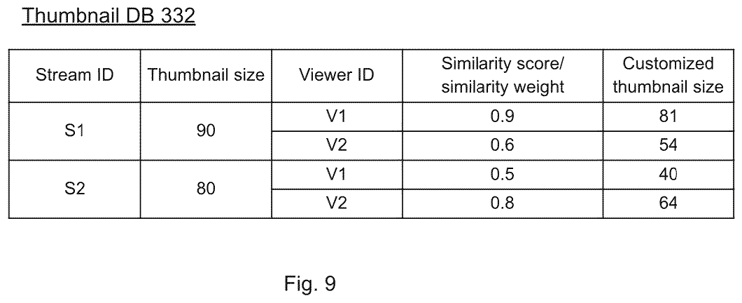

FIG. 9 is a data structure diagram showing an example of the thumbnail DB 332. The thumbnail DB 332 stores the stream ID, the thumbnail size, the viewer ID, the similarity score, and the customized thumbnail size, in association with each other.

The thumbnail size in FIG. 9 could correspond to the thumbnail size in FIG. 7, which is the thumbnail size determined according to interaction data. The viewer ID indicates the viewer to whom the recommendation page is displayed.

The similarity score/similarity weight indicates the similarity or the matching degree between the viewer and the stream room (or distributor of the stream room). The similarity score could be calculated by attribute data of the viewer and attribute data of the stream room/distributor. Various methods could be utilized. For example, dot product between attribute vector of the viewer and attribute vector of the stream room/distributor could be performed to calculate the similarity score. A higher similarity score indicates a higher chance that the viewer may like the content of the stream room (or may stay longer in the stream room). The attribute vector of a stream room may vary in a real time manner according to the real time content, such as the topic, in the stream room. Therefore, the similarity score could vary in a real time manner. In some embodiments, the ML DB 316 may be used to determine the attribute data of the viewer and/or the attribute data of the stream room.

The customized thumbnail size is determined according to the thumbnail size and each viewer's similarity score/similarity weight. For example, in this embodiment, the customized thumbnail size is the product of the thumbnail size and the similarity weight. The thumbnail size also varies in a real time manner, as described with reference to FIG. 7. Therefore, the customized thumbnail size could varies in a real time manner.

As shown, the thumbnail sizes determined by the interaction scores indicate that stream S1 (size 90) has a bigger thumbnail size than stream S2 (size 80). After considering the similarity weights, in the recommendation page shown to viewer V1, stream S1 (size 81) has a bigger thumbnail size than stream S2 (size 40). In the recommendation page shown to viewer V2, stream S1 (size 54) has a smaller thumbnail size than stream S2 (size 64). That is because viewer V2 has a higher similarity score with respect to stream S2.

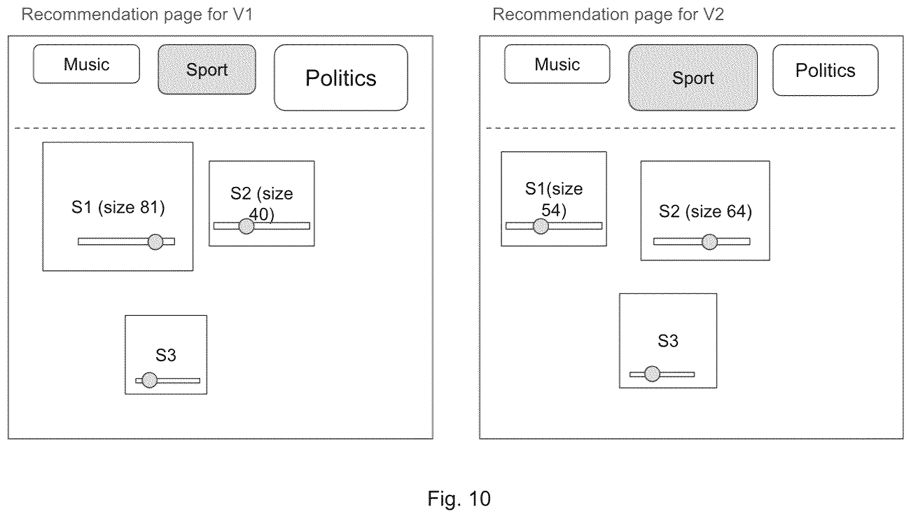

FIG. 10 shows an example of displaying a recommendation page in accordance with some embodiments of the present disclosure. FIG. 10 may correspond to the embodiment in FIG. 9.

As shown, the sizes of the genre tags and the sizes of the thumbnails shown in the recommendation page for viewer V1 are different from those shown in the recommendation page for viewer V2. Viewer V1 may have more preference toward the genre [Politics] than the genre [Sport]. Viewer V2 may have more preference toward the genre [Sport] than the genre [Politics]. The mechanism adjusts the size of the thumbnail according to each viewer's preference, and could enhance the chance of higher retention rate after each viewer joins a stream room.

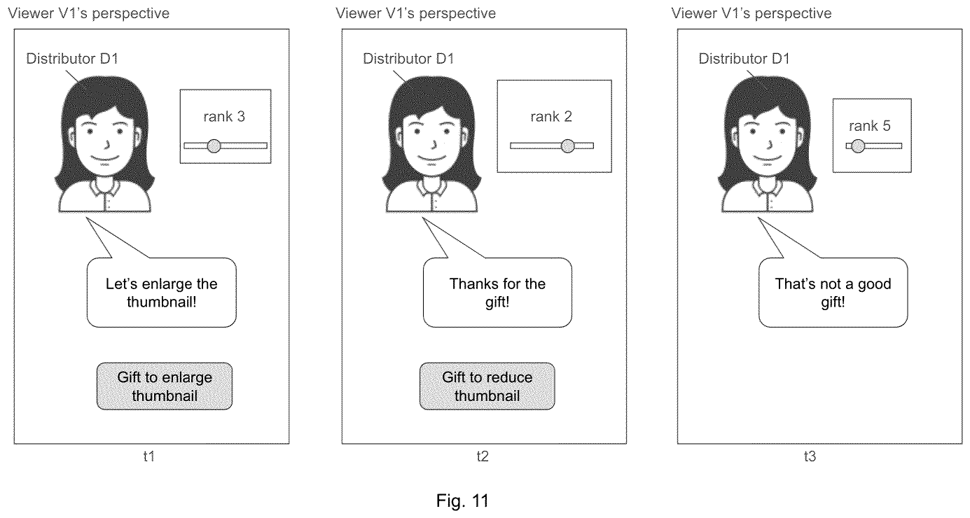

FIG. 11 shows an example of adjusting the thumbnail size in a stream room in accordance with some embodiments of the present disclosure. As shown, a preview of the thumbnail including a size indicator is shown in the stream room.

At timing t1, distributor D1 encourages her viewers to help enlarge the thumbnail size of her stream room in the recommendation page to attract more viewers. Viewer V1 selects [Gift to enlarge thumbnail] to send a gift to enlarge the thumbnail size.

At timing t2, the preview shows that the thumbnail in the recommendation page has been enlarged from rank 3 to rank 2 due to the gift from viewer V1. Distributor D1 expresses her gratitude. Subsequently, viewer V1 selects another gift to reduce the thumbnail size.

At timing t3, the preview shows that the thumbnail in the recommendation page has been reduced from rank 2 to rank 5 due to the gift from viewer V1. Distributor D1 expresses her complaint.

In some embodiments, in both cases (enlarging or reducing the thumbnail due to gift from viewer), the distributor can get the reward corresponding to the gift. Therefore the mechanism enables the viewers and the distributor to interact in a more interesting way. In some embodiments, a viewer may want to reduce the thumbnail size of distributor V1's stream room in order to help another distributor's exposure on the recommendation page. Even in that case, distributor D1 can get a reward so there would be no conflict on the streaming platform while distributors compete for the exposure on the recommendation page.

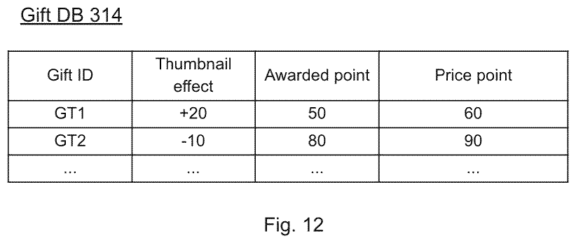

FIG. 12 is a data structure diagram showing an example of the gift DB 314. The gift DB 314 stores the gift ID, the thumbnail effect, the awarded point, and the price point, in association with each other.

The thumbnail effect indicates how the gift may affect the thumbnail size of a distributor's stream room while the gift is activated in the stream room. For example, gift GT1 has the effect of enlarging the thumbnail size by 20 points (or percentage). Gift GT2 has the effect of reducing the thumbnail size by 10 points (or percentage). In some embodiments, when a viewer sends a gift in a live stream room to adjust the thumbnail size, the processing unit 322 adjusts the thumbnail size on the recommendation page by referring to the gift DB 314.

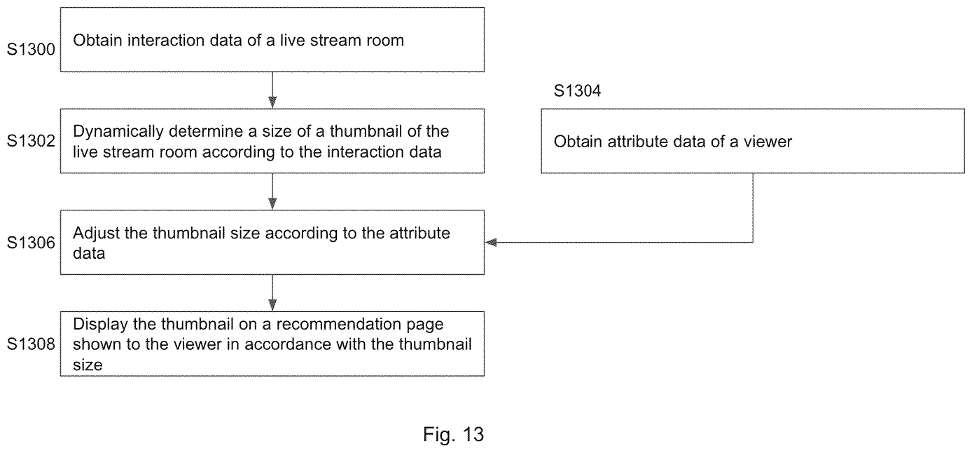

FIG. 13 shows an exemplary flow according to some embodiments of the present disclosure.

At step S1300, the obtaining unit 320 obtains interaction data of a live stream room.

At step S1302, the processing unit 322 dynamically determines the size of a thumbnail of the live stream room according to the interaction data.

At step S1304, the obtaining unit 320 obtains attribute data of a viewer.

At step S1306, the processing unit 322 adjusts the thumbnail size according to the attribute data. For example, the processing unit 322 may calculate the similarity score based on the attribute data and adjust the thumbnail size accordingly.

At step S1308, the processing unit 322 displays the thumbnail on a recommendation page shown to the viewer in accordance with the thumbnail size.

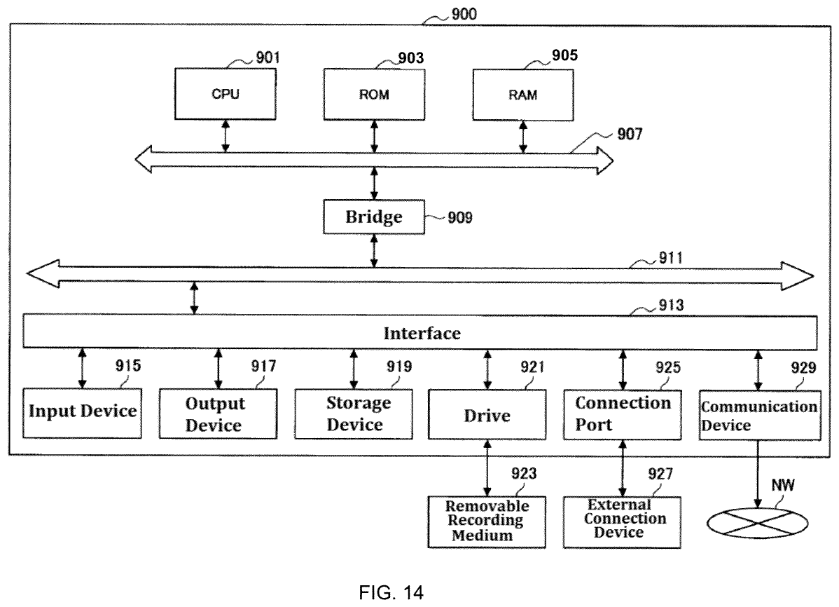

Referring to FIG. 14, the hardware configuration of the information processing device will be now described. FIG. 14 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes records in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system 1 in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

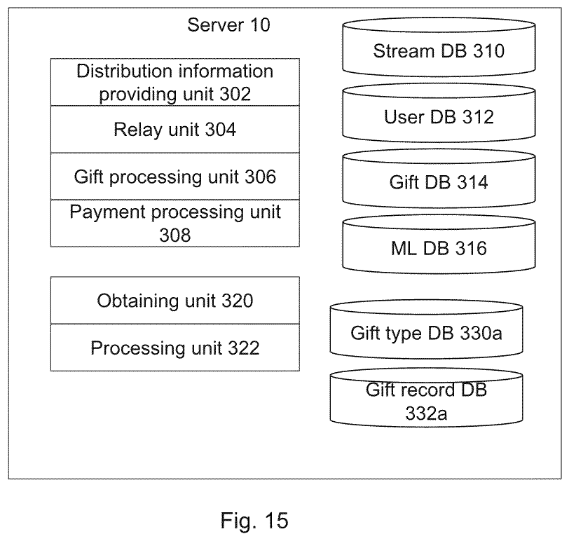

FIG. 15 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, a ML DB 316, an obtaining unit 320, a processing unit 322, a gift type DB 330a, and a gift record DB 332a.

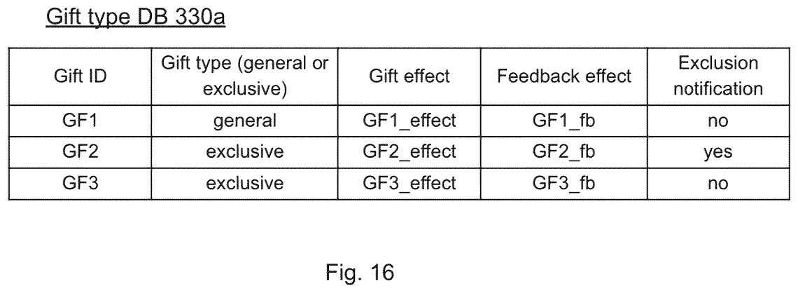

FIG. 16 is a data structure diagram showing an example of the gift type DB 330a. The gift type DB 330a stores gift ID, gift type, gift effect, feedback effect, and exclusion notification, in association with each other.

The gift ID identifies the gift. The gift type includes the general type and the exclusive type. For a general type gift, the gift effect is visible to all users in the steam room when the gift is given. For an exclusive type gift, the gift effect is visible only to exclusive users in the steam room when the gift is given. In some embodiments, the exclusive users include the viewer/gifter who sends the gift and the distributor who receives the gift.

The gift effect includes the URL that identifies the space wherein the effect data (for example, visual data or audio data) corresponding to the gift is stored. In some embodiments, when the obtaining unit 320 obtains a gifting signal from a gifter, the processing unit 322 refers to the gift type to determine who can see the gift effect, and to display the gift effect to them.

The feedback effect includes the URL that identifies the space wherein the feedback data corresponding to the gift is stored. Feedback data could include visual data or audio data expressing a gratitude message (or any kind of message) to the gifter. In some embodiments, feedback data could include pre-determined or pre-recorded visual data or audio data, such as pre-recorded data from the distributor. In some embodiments, feedback data could include or could be used to trigger an exclusive video or live video of the distributor that is displayed exclusively to the gifter and is not displayed to other viewers.

A feedback effect could be triggered by a gift effect. In some embodiments, when the obtaining unit 320 obtains a selection signal with respect to the gift effect from the distributor, the processing unit 322 refers to the feedback data and displays the feedback effect to the gifter and/or the distributor. In some embodiments, the feedback effect is only visible to the gifter and the distributor, and is invisible to other viewers and/or distributors. In some embodiments, after the distributor clicks/selects the gift effect to trigger a feedback effect, the processing unit 322 displays a live video of the distributor exclusively to the gifter for a predetermined time period.

The exclusion notification tag determines whether or not to display a notification to the users who cannot see the gift effect and/or the feedback effect. The notification may indicate the existence of the exclusive gift, the existence of the exclusive gift effect, and/or the existence of the feedback effect.

For example, when displaying one or more of the above effects exclusively to the gifter and/or the distributor, the processing unit 322 may display the exclusion notification to other viewers and/or distributors. The exclusion notification may include messages such as “Exclusive gift effect ongoing” or “Exclusive feedback effect ongoing”. For example, when the exclusive gift GF2 is sent, an exclusion notification will be shown to other viewers during the exclusive gift effect period and/or the exclusive feedback effect period. Other viewers will be curious about what is going on. Other users will want to see the exclusive gift effect and/or the feedback effect, and would be motivated to purchase the exclusive gift.

In some embodiments, there could be no notification regarding the exclusive gift effect and the feedback effect, so other viewers simply don't notice the gifting process of the exclusive gift. That mechanism may encourage some gifters to send the exclusive gifts when they don't want other viewers or distributors to notice the gifting process. For example, the exclusive gift GF3 does not trigger an exclusion notification to be shown.

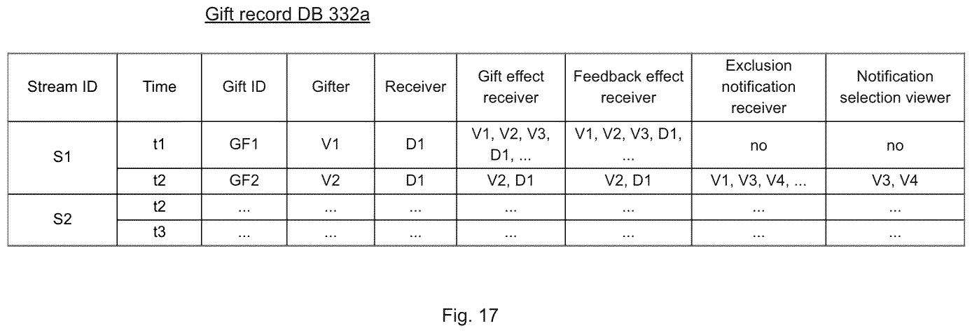

FIG. 17 is a data structure diagram showing an example of the gift record DB 332a. The gift record DB 332a stores stream ID, time, gift ID, gifter, receiver, gift effect receiver, feedback effect receiver, exclusion notification receiver, and notification selection viewer, in association with each other.

The time identifies the timing or time span. The gifter identifies who sends the gift. The receiver identifies to whom the gift is sent to. The gift effect receiver identifies the users to whom the gift effect is displayed. The feedback effect receiver identifies the users to whom the feedback effect is displayed. The exclusion notification receiver identifies the users to whom the exclusion notification is displayed. The notification selection viewer identifies who selects/clicks the exclusion notification.

For example, at timing t1, a general gift GF1 is sent from viewer V1 to distributor D1 in the live stream S1. Because it is a general gift, the gift effect and the feedback effect are displayed to all users in the stream room. There is no exclusion notification. In some embodiments, there could be no feedback effect for a general gift.

For example, at timing t2, an exclusive gift GF2 is sent from viewer V2 to distributor D1 in the live stream S1. Because it is an exclusive gift, the gift effect and the feedback effect are exclusively displayed to V2 and D1. The exclusion notification is displayed to other users in the stream room. Within those other users, viewers V3 and V4 selected the exclusion notification, which may trigger a gifting process for them.

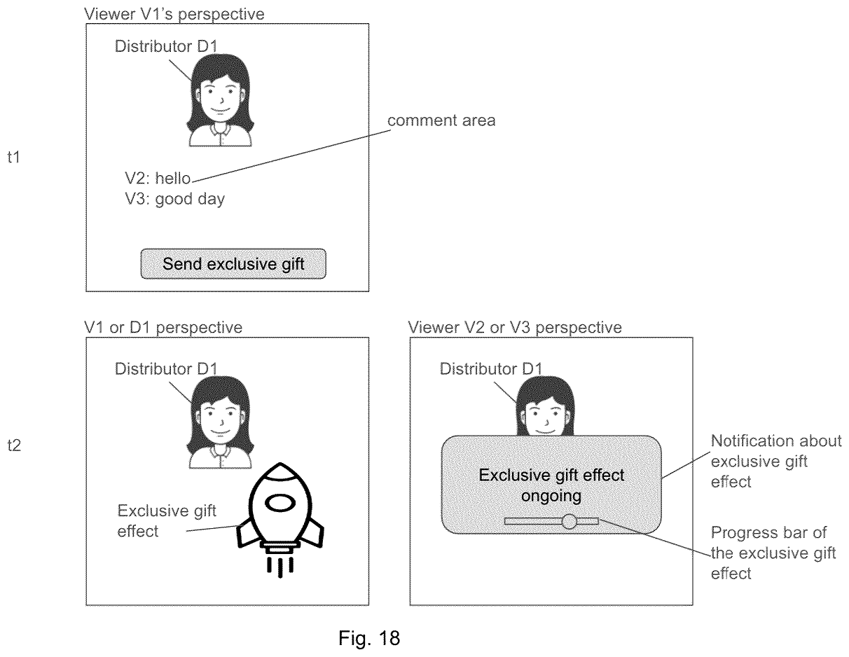

FIG. 18 shows an example of live streaming in accordance with some embodiments of the present disclosure.

At timing t1, viewer V1 sends an exclusive gift to distributor D1. Other viewers V2 and V3 leave comments in the stream room.

At timing t2, the exclusive gift effect corresponding to the exclusive gift is displayed to viewer V1 and distributor D1. A notification indicating the existence of the exclusive gift effect is displayed to other viewers. A progress bar of the exclusive gift effect could be shown to express the progress of the effect.

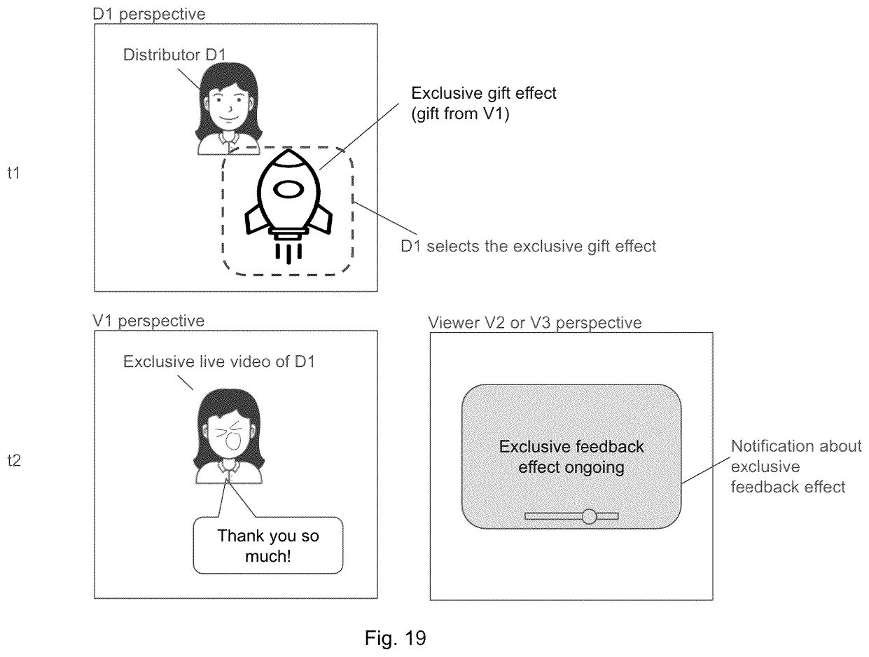

FIG. 19 shows an example of live streaming in accordance with some embodiments of the present disclosure.

At timing t1, distributor D1 selects (such as by clicking or tapping through an user interface of the user terminal of distributor D1) the exclusive gift effect corresponding to an exclusive gift sent from viewer V1. That may trigger the exclusive feedback effect.

At timing t2, the processing unit 322 displays an exclusive live video (which is the feedback effect) of distributor D1 exclusively to viewer V1. Viewers V2 and V3 cannot see the feedback effect, instead, they see a notification indicating the existence of the exclusive feedback effect.

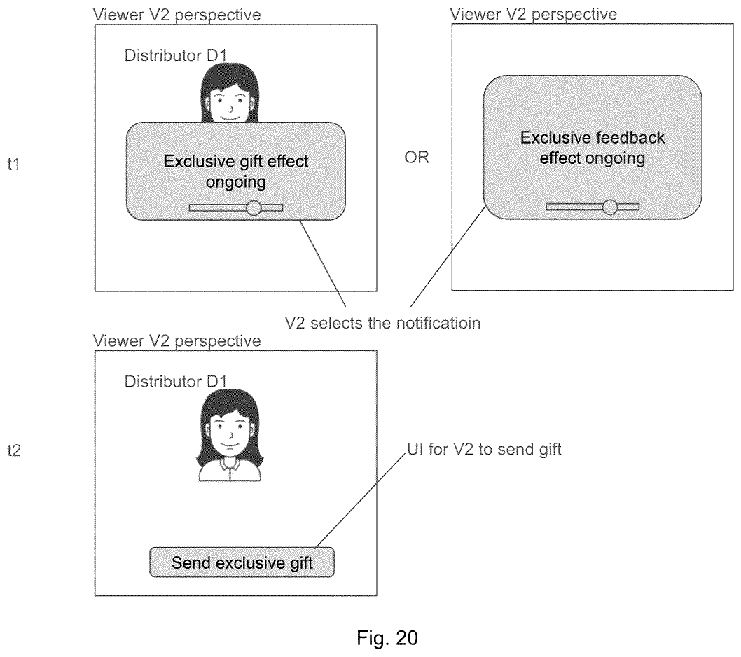

FIG. 20 shows an example of live streaming in accordance with some embodiments of the present disclosure.

At timing (or time span) t1, viewer V2 sees a notification indicating the existence of an exclusive gift effect and/or a notification indicating the existence of an exclusive feedback effect. The exclusive gift could be sent from another viewer to distributor D1. Viewer V2 selects the notification. That triggers a gifting processing for viewer V2.

At timing t2, a UI is displayed to viewer V2 for him/her to send an exclusive gift to distributor D1. When viewer V2 selects the “end exclusive gift”, a gifting process will be performed.

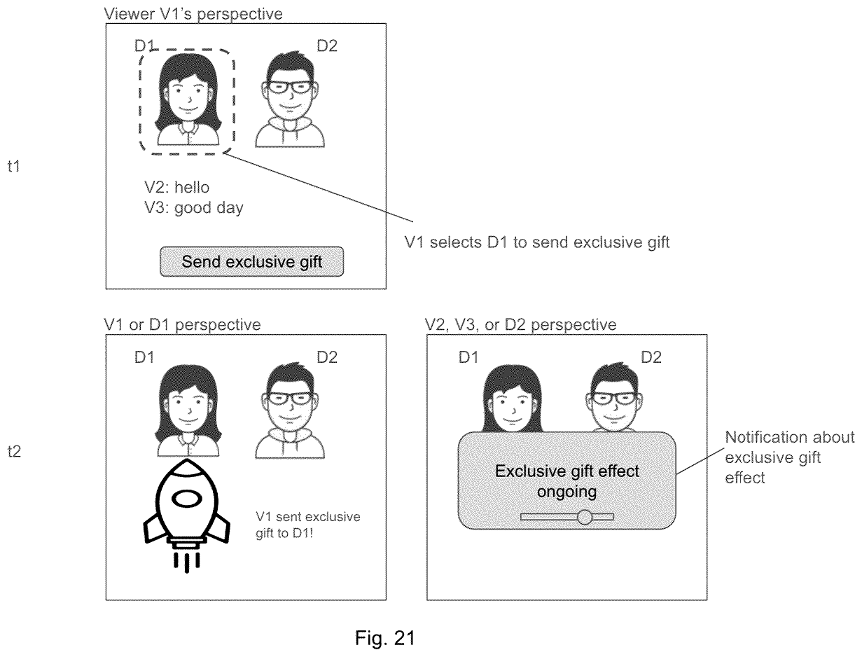

FIG. 21 shows an example of live streaming in accordance with some embodiments of the present disclosure.

At timing t1, distributor D1 and distributor D2 are performing in the same live stream room. That could be a multi-distributor streaming mode, such as a PK mode. Live video of distributor D1 and live video of distributor D2 are displayed on the user terminal of viewer V1 simultaneously. Viewer V1 selects distributor D1 to send the exclusive gift.

At timing t2, an exclusive gift effect is displayed to viewer V1 and distributor D1. For other users in the live stream room, they can only see a notification about the existence of the exclusive gift effect. In some embodiments, there could be no notification, and the whole gifting process is unknown for other users.

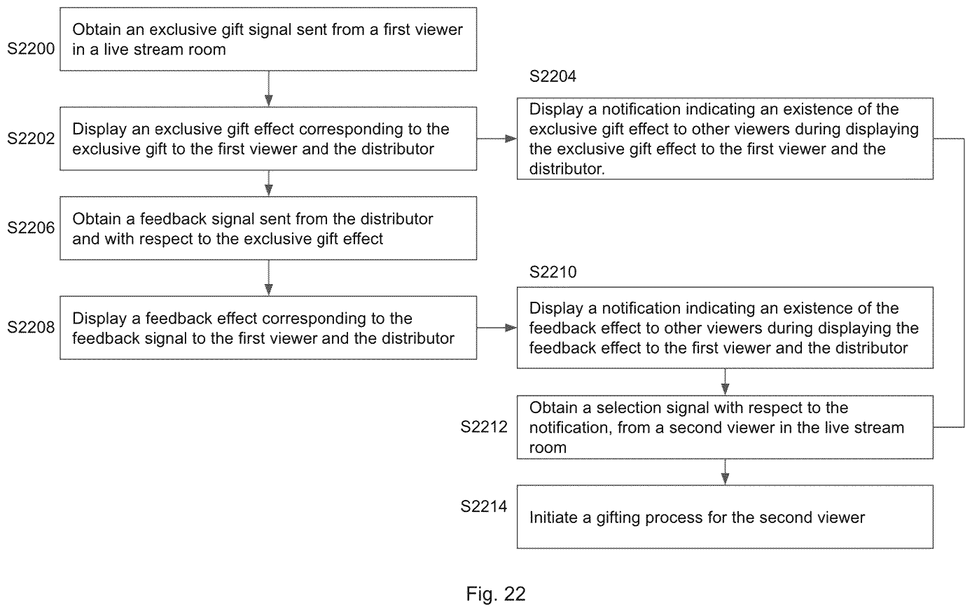

FIG. 22 shows an exemplary flow according to some embodiments of the present disclosure.

At step S2200, the obtaining unit 320 obtains an exclusive gift signal sent from a first viewer in a live stream room. The exclusive gift is sent to a distributor of the live stream room.

At step S2202, the processing unit 322 displays an exclusive gift effect corresponding to the exclusive gift exclusively to the first viewer and the distributor.

At step S2204, the processing unit 322 displays a notification indicating an existence of the exclusive gift effect to other viewers during displaying the exclusive gift effect to the first viewer and the distributor.

At step S2206, the obtaining unit 320 obtains a feedback signal sent from the distributor and with respect to the exclusive gift effect. For example, the distributor clicks or taps the exclusive gift effect.

At step S2208, the processing unit 322 displays a feedback effect corresponding to the feedback signal exclusively to the first viewer and the distributor.

At step S2210, the distributor displays a notification indicating an existence of the feedback effect to other viewers during displaying the feedback effect to the first viewer and the distributor.

In step S2204 or step S2210, if a second viewer (of the other viewers) selects the notification, the flow goes to step S2212.

At step S2212, the obtaining unit 320 obtains a selection signal with respect to the notification, from a second viewer in the live stream room.

At step S2214, the processing unit 322 initiates a gifting process for the second viewer

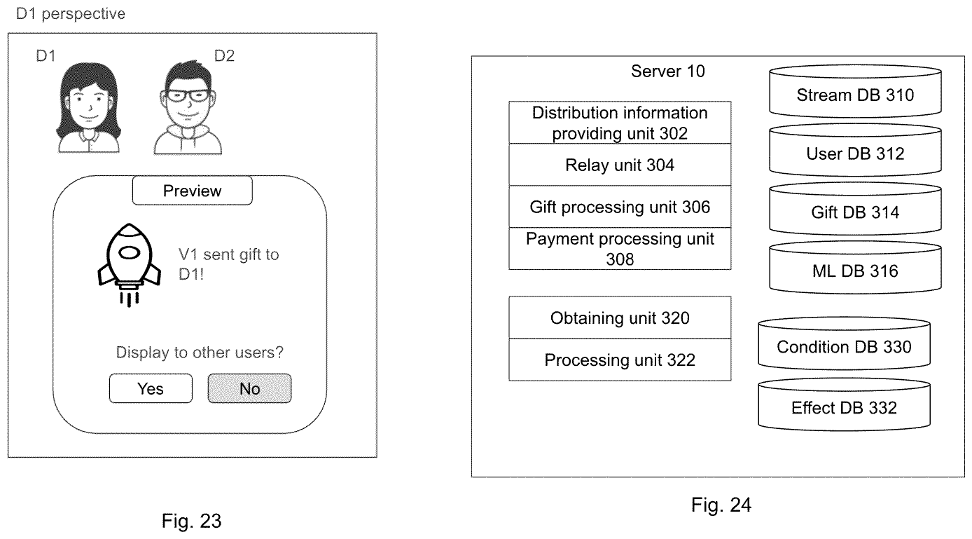

FIG. 23 shows an example of live streaming in accordance with some embodiments of the present disclosure.

As shown, when viewer V1 sends a gift to distributor D1, a preview of the gift is firstly shown to distributor D1 exclusively, by the processing unit 322, for example. Distributor D1 then can select whether or not to display the gift effect to other users (such as viewers and distributors) in the live stream. In some embodiments, a distributor may like to keep low key and does not want other viewers or distributors to know how much reward he/she earns. Depending on the selection result of distributor D1, the gift effect will be shown to distributor D1 exclusively, or to distributor D1 and other users, after the preview ends.

FIG. 24 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, a ML DB 316, an obtaining unit 320, a processing unit 322, a condition DB 330b, and an effect DB 332b.

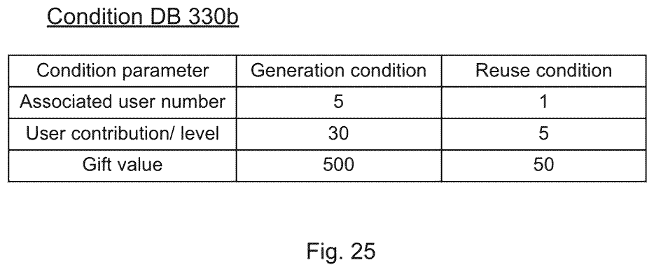

FIG. 25 is a data structure diagram showing an example of the condition DB 330b. The condition DB 330b stores condition parameter, generation condition (or generation criteria), and reuse condition (or reuse criteria), in association with each other.

The condition DB 330b stores the conditions to utilize ML DB 316 to generate effects and the conditions to reuse the generated effects. The condition parameter identifies the type of the condition/criteria to trigger an effect's generation or reuse according to a topic. The generation condition identifies the threshold of the condition parameter to generate the effect. The reuse condition identifies the threshold of the condition parameter to reuse the effect.

The associated user number identifies the number of users associated with a topic. For example, the user may comment about the topic, react/reply to the topic, or send a gift related to the topic. The user contribution/level identifies the user level of a user who is associated with a topic. The user level may increase with the user's contribution (such as gifting/payment/ depositing/interaction) on the live streaming platform. The gift value identifies a value of a gift sent by a user who is associated with a topic.

For example, when the number of users who are associated with a topic reaches 5, the condition of generating an effect according to the topic is satisfied. The generated effect is saved. Subsequently, when the number of users who are associated with the same topic reaches 1, the condition of reusing the effect corresponding to the topic is satisfied.

For example, when there is one user mentioning a topic and the level of the user is equal to or greater than 30, the condition of generating an effect according to the topic is satisfied. The generated effect is saved. Subsequently, when there is another user mentioning the same topic and the level of that user is equal to or greater than 5, the condition of reusing the effect corresponding to the topic is satisfied.

For example, when a user sends a gift with a gift value equal to or greater than 500, the condition of generating an effect according to a topic associated with the user is satisfied. The generated effect is saved. Subsequently, when a user sends a gift with a gift value equal to or greater than 50, the condition of reusing the effect corresponding to the topic is satisfied. In some embodiments, the user may need to specify the same topic before reusing the effect.

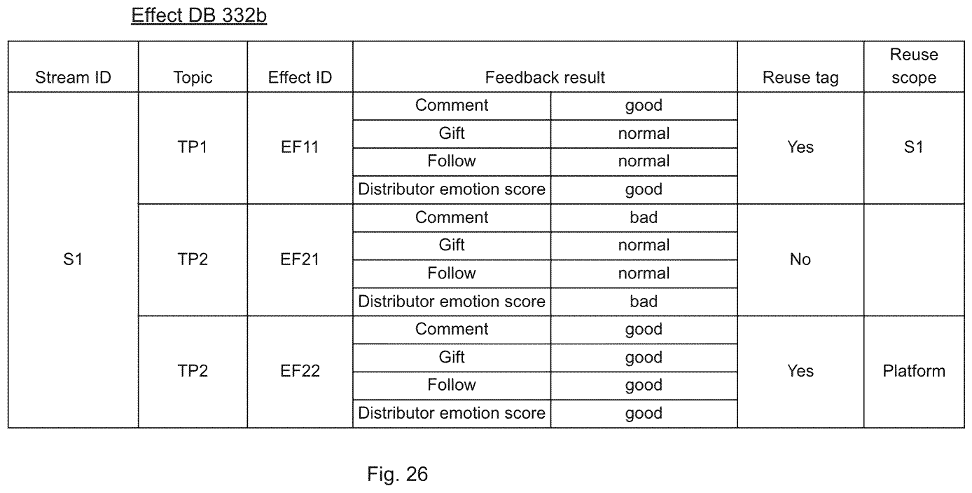

FIG. 26 is a data structure diagram showing an example of the effect DB 332b. The effect DB 332b stores stream ID, topic, effect ID, feedback result, reuse tag, and reuse scope, in association with each other.

The stream ID identifies a live stream. The topic identifies each topic that has met the effect generation condition such that an effect corresponding to the topic is generated. The obtaining unit 320 may monitor the data in the live stream and refer to the condition DB 330b to determine the topics that meet the conditions.

The effect ID identifies the generated effect corresponding to the topic. The effect ID could correspond to an URL directed to a space wherein the generated effect is stored. The effect could include image, audio or video data corresponding to the topic. The processing unit 322 may input the topic as a prompt into the ML DB 316 to generate the effect. The effect may be displayed by the processing unit 322 in the live stream.

The feedback result indicates how users in the live stream react/respond to the effect, and includes various feedback parameters such as comment, gift, follow, and distributor emotion score. For example, a “good” result may correspond to an increase or a positive change rate of the comment, gift, follow, or the distribution emotion score, after the effect is displayed. A “bad” result may correspond to a decrease or a negative change rate of the comment, gift, follow, or the distribution emotion score, after the effect is displayed. A “normal” result may correspond to the situation wherein no obvious change could be observed after the effect is displayed. Thresholds (such as value threshold or change rate threshold) could be set to make the result determination. The distributor emotion score could be determined by various methods. For example, the processing unit 322 and/or the ML DB 316 may analyze the video/audio data of the live stream to determine the emotion level of the distributor. An increase in the emotion score after the effect is displayed may reflect an emotion spike (such as happiness, scare, surprise, etc) of the distributor. The feedback parameters may be monitored by the obtaining unit 320, and the result may be determined by the processing unit 322 according to the feedback parameters.

The reuse tag indicates whether or not the generated effect would be saved for later reuse. A “yes” reuse tag means the feedback result is good enough such that the effect is worth being stored for later reuse (when the reuse condition is met). The effect is stored to be corresponding to the topic based on which the effect is generated. A “no” reuse tag means the feedback result is not good enough so there is no need to save the effect for later reuse. Various criteria could be used to determine the reuse tag according to the actual practice. For example, when a certain amount of feedback parameters are “good”, or when a particularly important feedback parameter is “good”, the reuse tag could be “yes”. In some embodiments, only the effect with the reuse tag “yes” is stored for a long term.

The reuse scope identifies the scope of reusing the stored effect, when the corresponding topic or a similar topic meets the reuse condition in the scope. Various criteria could be used to determine the reuse scope according to the actual practice. For example, a better feedback result could result in a broader reuse scope.

In this example, half of the feedback parameters corresponding to the effect EF11, which corresponds to the topic TP1, are “good”, therefore, the reuse scope is within live stream S1. That means, when the topic TP1 or a similar topic is detected (by ML DB 316, for example) to meet the reuse condition in live stream S1, the effect EF11 could be reused to display within live stream S1, without needing to generate a new effect. In this example, all of the feedback parameters corresponding to the effect EF22, which corresponds to the topic TP2, are “good”, therefore, the reuse scope is the whole live streaming platform. That means, when the topic TP2 or a similar topic is detected to meet the reuse condition in any live stream on the live streaming platform, the effect EF22 could be reused to display within that live stream, without needing to generate a new effect.

Note that the feedback results for the effect EF21, which corresponds to the topic TP2, are not good, therefore the effect EF21 is not saved for later reuse. In that case, when the topic TP2 meets the generation condition again, a new effect EF22 is generated.

As shown in the condition DB 330b, the reuse condition could be looser than the generation condition. In some embodiments, the cost of generating an effect in a real time manner could be much higher than the cost of reusing a stored effect. Therefore, reusing effects having good feedback results could increase the engagement while minimizing the cost for the live streaming platform.

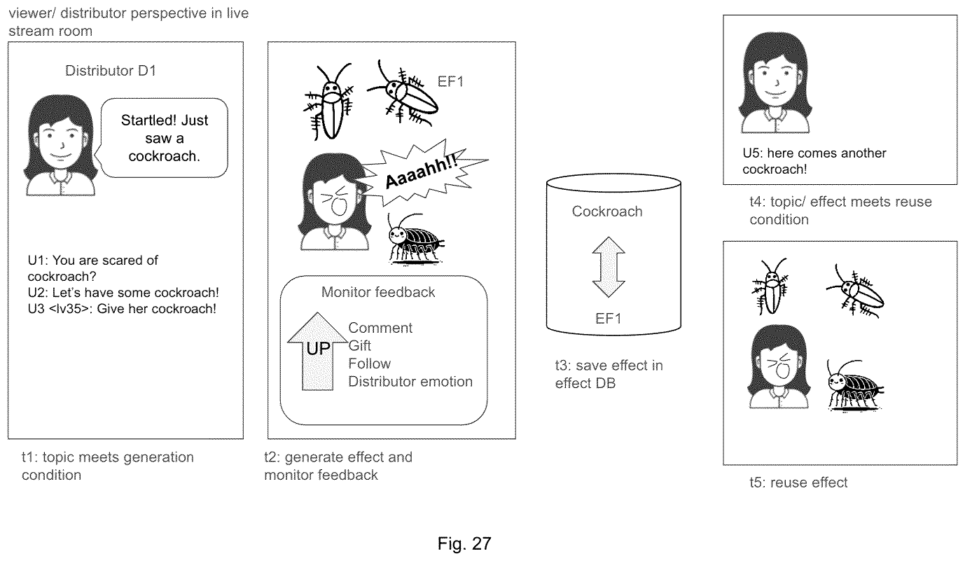

FIG. 27 shows an example of live streaming in accordance with some embodiments of the present disclosure. The UI could be the perspective of the distributor or a viewer.

At timing t1, distributor D1 mentions that she is startled by a cockroach. Viewers find that funny and keep mentioning the topic “cockroach”. The amount of the viewers mentioning the topic and/or the high level of viewer U3 who mentions the topic enables the topic to meet the effect generation condition.

At timing t2, the topic “cockroach” is input into the ML DB 316 as a prompt to generate an effect EF1. The obtaining unit 320 monitors the feedback data in the live stream, including reaction of the distributor and interaction data of the viewers. The feedback data shows increased engagement and the effect EF1 is determined to be good and worth being saved for later reuse.

At timing t3, the processing unit 322 saves the effect EF1 in correspondence with the topic “cockroach”.

At timing t4, only one viewer U5 mentions the topic “cockroach” again and triggers the effect reuse condition (which is looser than the effect generation condition).

At timing t5, the effect EF1 is reused and is displayed in the live stream.

Note that if the feedback is very good, the reuse scope could extend beyond the live stream of distributor D1. In that case, the description above related to timings t4 and t5 could apply to other live streams on the live streaming platform.

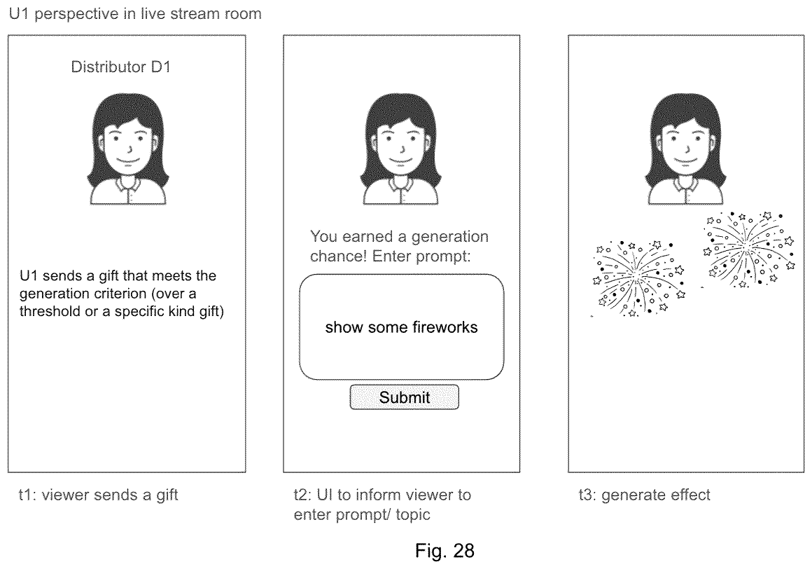

FIG. 28 shows an example of live streaming in accordance with some embodiments of the present disclosure. The UI could be the perspective of a viewer.

At timing t1, viewer U1 sends a gift that meets the generation criterion. For example, the gift value is over a threshold value or the gift is a specific kind gift to generate effect.

At timing t2, a notification box is displayed (by the processing unit 322, for example) to notify the viewer that he/she earns a generation chance and can enter a prompt to generate an effect. Viewer U1 enters “show some fireworks” and submits the prompt.

At timing t3, the topic “firework” is input into the ML DB 316 as a prompt to generate the effect.

Same as the example in FIG. 27, if the feedback is good, the effect could be saved for later reuse. When an effect's generation is triggered by a gift sending, the reuse condition is not limited to gift sending. For example, when the firework effect is saved, a viewer could comment about the topic and trigger the reuse of the effect.

In some embodiments, when an effect is reused, a certain amount of points would be deducted from the user who triggers the effect reuse. In some embodiments, an UI may be shown to ask the user who triggers the reuse condition whether he/she wants to reuse the effect or simply to send a comment without triggering the effect reuse. In some embodiments, an UI may be displayed to inform the user who triggers the reuse condition that the effect is already saved and could be reused by sending a reuse gift that is cheaper than a generation gift.

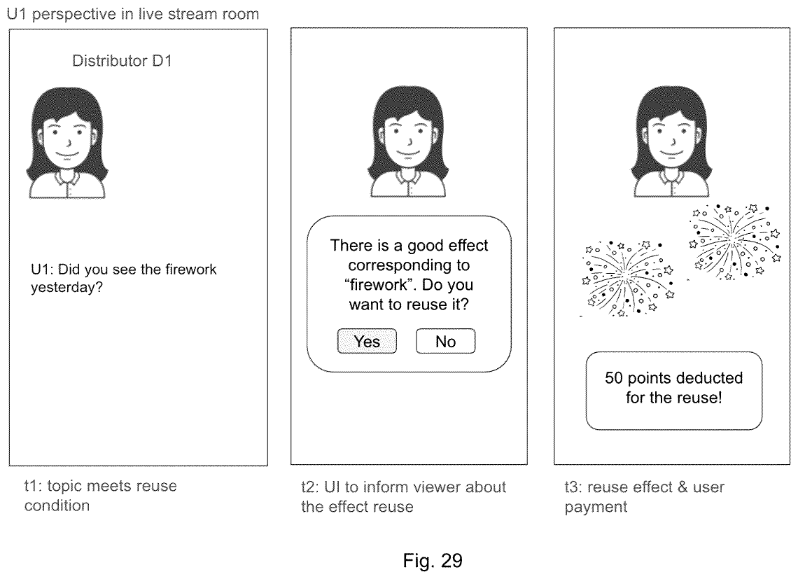

FIG. 29 shows an example of live streaming in accordance with some embodiments of the present disclosure. The UI could be the perspective of a viewer.

At timing t1, viewer U1 mentions about “firework” and satisfies the reuse condition for a saved effect corresponding to the topic.

At timing t2, the processing unit 322 displays an UI to convey “There is a good effect corresponding to “firework”. Do you want to reuse it?”. Viewer U1 selects “yes”.

At timing t3, the effect is reused. An UI is displayed to inform viewer U1 that an amount of points is deducted for the effect reuse. The present disclosure may motivate users to find out and to reuse the saved effects.

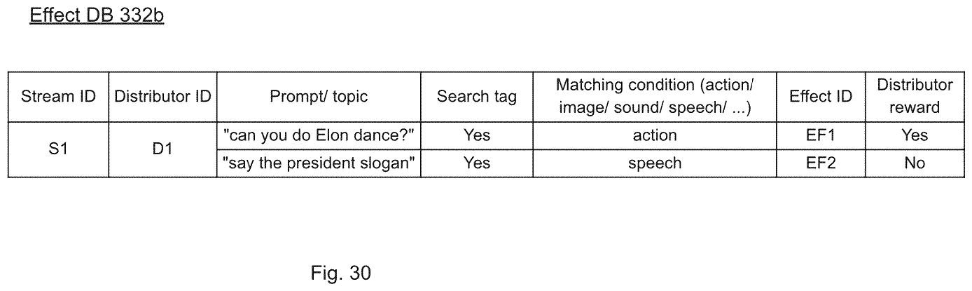

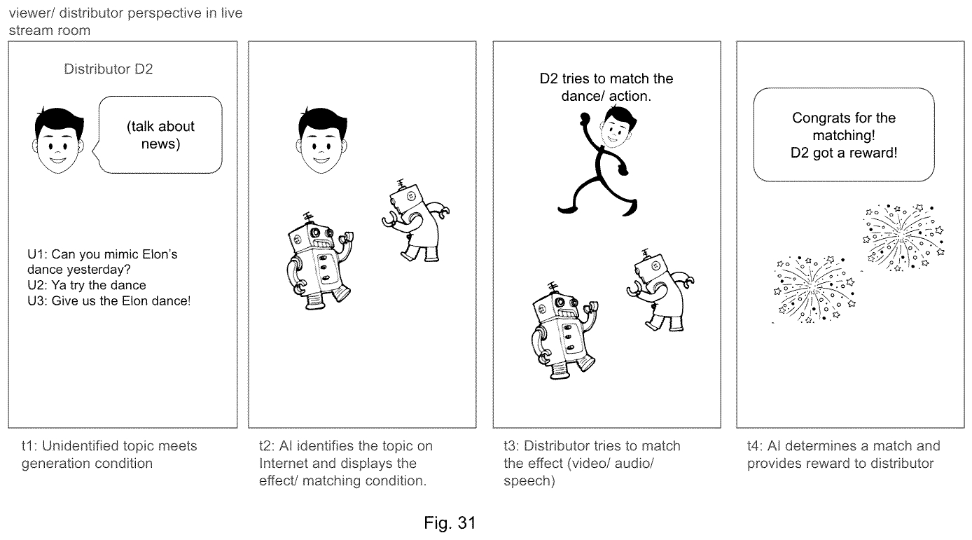

FIG. 30 is a data structure diagram showing another example of the effect DB 332b. The effect DB 332b stores stream ID, distributor ID, prompt/topic, search tag, matching condition, effect ID, and distributor reward, in association with each other.

The prompt/topic identifies the prompt/topic that has met the effect generation condition such that an effect corresponding to the prompt would be generated. The obtaining unit 320 may monitor the data in the live stream and refer to the condition DB 330b to determine the prompts that meet the conditions.

When the prompt/topic meets the generation condition, the processing unit 322 inputs the prompt into the ML DB 316 to generate the effect. The ML DB 316 needs to understand/recognize the meaning of the prompt in order to generate the effect. In some embodiments, the ML DB 316 may not recognize the prompt with an inherent database and needs to search on the Internet (or external data) to understand the prompt. In that case, the search tag is “yes”. The processing unit 322 may cooperate with the ML DB 316 in the search. If the ML DB 316 can understand the prompt with its inherent database, the search action may not be needed.

In some embodiments, the ML DB 316 may analyze the prompt (such as contextual/textual analysis) and determine whether or not the prompt includes/implies/requires a matching condition in the generated effect. The matching condition could have the form of action, image, sound or speech. The matching condition identifies the condition/criterion/form with which the distributor needs to match the effect. The matching condition identifies how the distributor may match the effect. In some embodiments, the matching condition will be shown in the live stream such that the distributor can have a hint of how to match. In some embodiments, the matching condition may not be shown in the live stream and the distributor needs to figure out how to match.

For example, a high-level user comments “can you do Elon dance?”, which triggers the effect generation. The ML DB 316 searches on the Internet and understands that “Elon dance” most likely refers to a latest dance performed by a celebrity called Elon. ML DB 316 determines the proper form of matching condition is “action”.

For example, a user sends a specific effect gift and enters the prompt “say the president slogan” to trigger the effect generation. The ML DB 316 searches on the Internet and understands that “president slogan” most likely refers to a latest slogan said by a president (such as “make the world better!”). ML DB 316 determines the proper form of matching condition is “speech”.

The effect ID identifies the effect generated by the ML DB 316 based on the prompt. The distributor reward identifies whether or not the distributor matches the matching condition and wins the reward.

FIG. 31 shows an example of live streaming in accordance with some embodiments of the present disclosure. The UI could be the perspective of a viewer or distributor.

At timing t1, the distributor D2 is talking about news. Viewers'comments include “can you mimic Elon's dance yesterday”, “Ya try the dance”, and “Give us the Elon dance!”. Based on the contextual/textual analysis on viewers' comments and by referring to the condition DB 330b (or user DB which could include user's level), ML DB 316 determines that the topic “Elon's dance (yesterday)” meets the effect generation condition. The ML DB 316 also determines, from the textual analysis, that a matching condition is associated with the topic.

The topic “Elon's dance yesterday” is not existent in ML DB 316's original database. Therefore at timing t2, ML DB 316 searches on the Internet and confirms/identifies that it refers to a latest dance/action by a celebrity called Elon. ML DB 316 then determines the matching condition to be “action”. ML DB 316 and/or processing unit 322 generates the effect according to the knowledge about the actual dance, and displays the effect in the live stream. The effect may correspond to or may include the matching condition, which could serve as a hint of the action to be matched.

At timing t3, distributor D2 performs the dance action and tries to match the effect.

At timing t4, ML DB 316 determines a successful match between the distributor's action and the effect has been achieved. The processing unit 322 displays the congratulation effect. An UI is displayed to indicate “Congrats for the matching! D2 got a reward!”

In some embodiments, if the topic is identified by the ML DB 316 to be a slogan or phrase, ML DB 316 may determine the matching condition to be “speech”. In that case, the distributor needs to speak the correct content to match the effect. In some embodiments, if the topic is identified by the ML DB 316 to be a song (or portion of a song), ML DB 316 may determine the matching condition to be “melody” or “singing”. In that case, the distributor needs to sing the correct content to match the effect. In some embodiments, if the topic is identified by the ML DB 316 to be a facial expression or a posture, ML DB 316 may determine the matching condition to be “image”. In that case, the distributor needs to perform the correct facial expression or the correct posture to match the effect.

In some embodiments, ML DB 316 may display the effect as a reference content of the matching condition in the video, image, text, or sound form. For example, an animated expression could be displayed for the distributor to match.

In some embodiments, ML DB 316 could be pretrained (by prompting, for example) to search on Internet when it is not sure what a topic refers to based on its existent database. In some embodiments, ML DB 316 could be pretrained (by prompting, for example) to determine if there is any matching condition required in comments/prompts associated to the topic. The ML DB 316 may analyze the prompt and determine whether or not it contains a matching condition. In some embodiments, ML DB 316 could be pretrained (by prompting, for example) to determine the matching condition (such as the expression form) according to the content of the topic.

For example, if the prompt from a viewer to generate the effect is “do some push-ups”, since ML DB 316 understands what it means, there is no need to search on the Internet. ML DB 316 may determine there is a requirement/matching condition in the prompt. ML DB 316 may determine the matching condition to be “action” (or “video”). ML DB 316 may display an animated version of push-up action in the live stream as the effect (or part of the effect). Once ML DB 316 determines the distributor's action matches the effect, the processing unit 322 may provide reward to the distributor. A deduction of points from the viewer who triggers the effect may be performed.

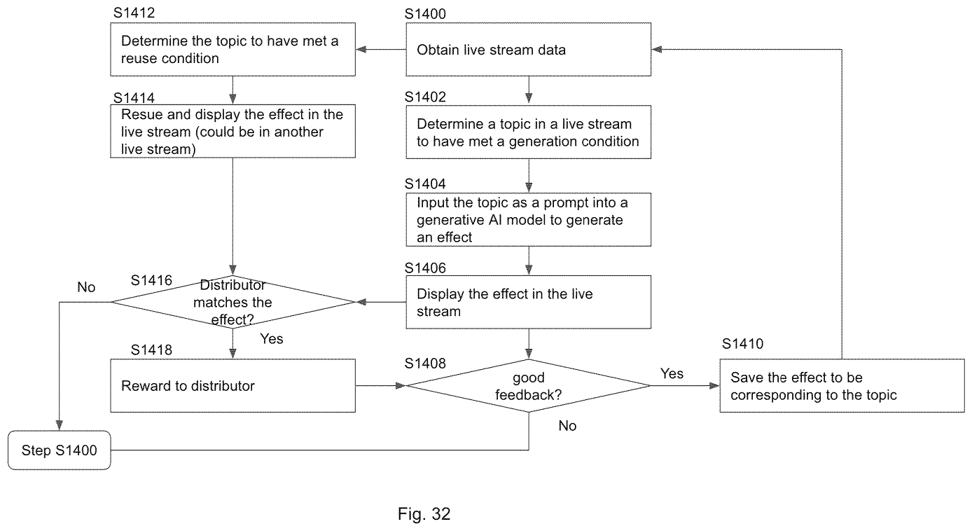

FIG. 32 shows an exemplary flow according to some embodiments of the present disclosure.

At step S1400, obtaining unit 320 obtains live stream data on the live streaming platform. Live stream data may include interaction data and/or user data within various live streams.

At step S1402, the processing unit 322 determines a topic in a live stream to have met a generation condition to generate an effect.

At step S1404, the processing unit 322 inputs the topic as a prompt into a generative AI model to generate an effect.

At step S1406, the processing unit 322 displays the effect in the live stream.

At step S1408, the processing unit 322 determines if the effect caused good feedback in the live stream. If yes, the flow goes to step S1410. If not, the flow goes back to step S1400.

At step S1410, the effect is saved to be corresponding to the topic in an effect database. The flow then goes back to step S1400 wherein data of all live steams are continuously monitored.

At step S1412, the same topic (or a similar topic) is mentioned again in the same live stream or in another live stream. The processing unit 322 determines the topic to have met a reuse condition to reuse the effect corresponding to that topic. The processing unit 322 may check if the effect DB 332b already stores the topic (or similar topic) and its corresponding effect.

At step S1414, the processing unit 322 reuses and displays the effect in the live stream (could be different from the live stream room wherein the effect was generated in the first place). In some embodiments, the reuse process may not involve a generative AI model and the cost is cheap.

At step S1416, ML DB 316 determines if the distributor matches the effect. If yes, the flow goes to step S1418. If not, the flow goes back to step S1400. In this example, the topic/prompt to generate the effect is determined by ML DB 316 to include a matching condition.

At step S1418, the processing unit 322 rewards the distributor for the successful matching. The flow may then go to step S1408 or may go back to step S1400.

In some embodiments, the reuse condition could be tighter than the generation condition. For example, when a generated effect is very popular in a live stream, the processing unit 322 may display an UI to indicate a tighter reuse condition such that more users will be motivated to engage. For example, the reuse condition may require more viewers to mention the topic in order to re-display the effect.

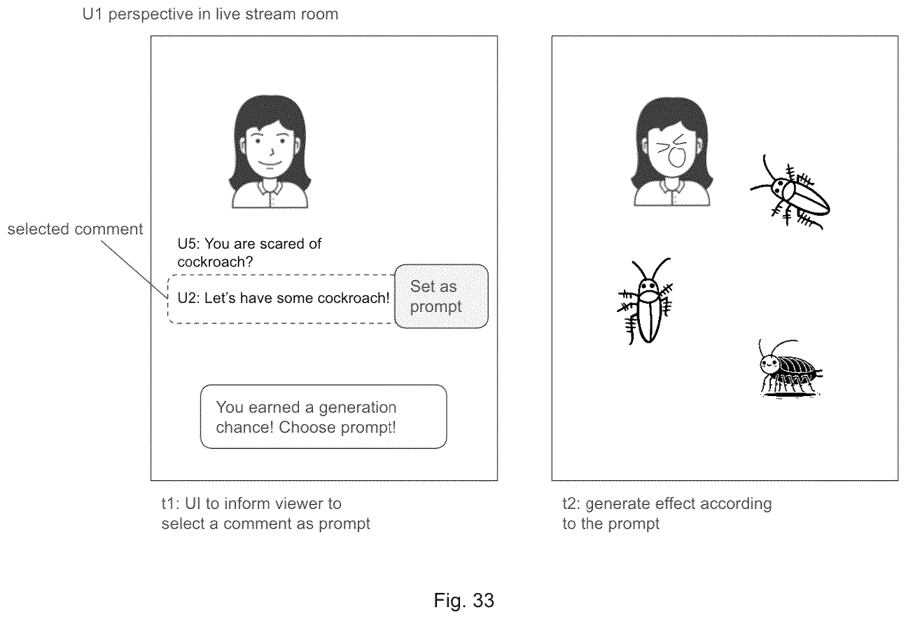

FIG. 33 shows an example of live streaming in accordance with some embodiments of the present disclosure. The UI could be the perspective of a viewer.

At timing t1, the processing unit 322 shows an UI to inform viewer U1 that he/she earns an effect generation chance and can select a prompt. Viewer U1 selects a comment “Let's have some cockroach!” from another viewer and clicks “Set as prompt”.

At timing t2, an effect generated by the prompt is displayed in the live stream.

In some embodiments, sending some specific gift may allow a viewer to choose another viewer's comment as the prompt to generate the effect. That may improve the engagement between users in the live stream.

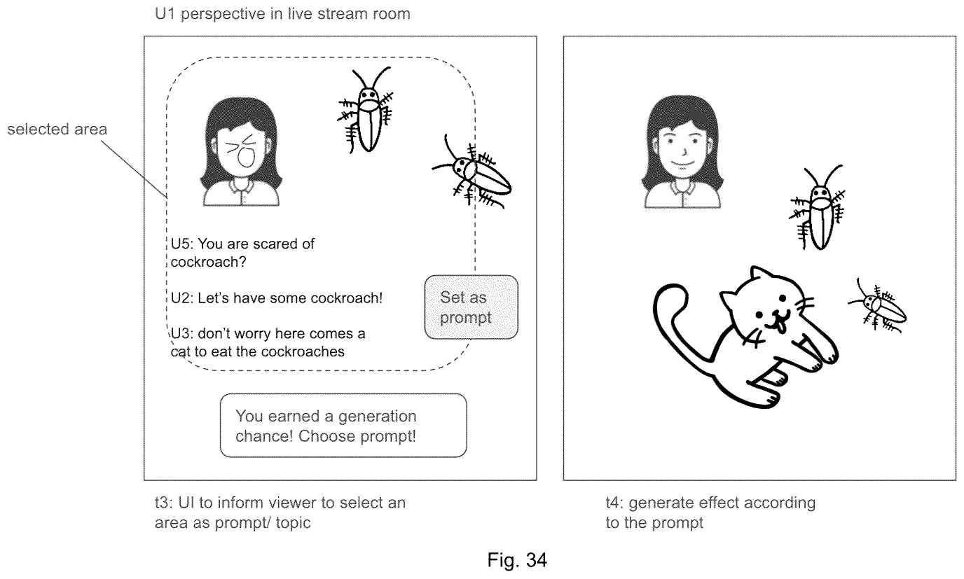

FIG. 34 shows an example of live streaming in accordance with some embodiments of the present disclosure. The UI could be the perspective of a viewer. The example in FIG. 34 could be a situation following the example in FIG. 33.

At timing t3, another viewer U3 comments “don't worry here comes a cat to eat the cockroaches”. An UI is displayed again to inform viewer U1 that he/she earns another effect generation chance. For example, viewer U1 may have sent another gift to earn the chance. Viewer U1 then selects an area and clicks “Set as prompt”, to input the area (such as screen shot) as a prompt into the ML DB 316 to generate the effect.

At timing t4, ML DB 316 analyzes the area and generates a cat chasing those cockroaches.

In some embodiments, sending some specific gift may allow a viewer to identify an area in the live stream as the prompt to generate the effect. ML DB 316 may be pretrained to understand that when a screen shot is input as a prompt, it should generate an image/video that follows the input screen shot or satisfies users'needs in the screen shot.

In some embodiments, selecting a comment or an area as a prompt may happen before the gift is sent. For example, the viewer may select a comment or an area, then an UI may be displayed to indicate “Want to utilize this prompt to generate an effect? Send a gift!”. After the viewer selects to send the gift, the comment or area would be input to ML DB 316 to generate the effect. This may further motivate the viewer to send a gift.

In some embodiments, a viewer can pay or can send a specific gift to save an effect. For example, when an effect is generated, a viewer may select the effect (before the effect is gone, or within a predetermined time period) and a UI may be displayed to ask if the viewer wants to save it for later reuse. The viewer may also enter a keyword to be saved in corresponding to the effect. Subsequently, the viewer (or another viewer) may reuse the effect by entering the keyword or the topic that was used to generate the effect in the first place.

In some embodiments, the live streaming platform could provide a leaderboard or a gallery wherein good generated effects are stored. The effects could be ranked by its reuse number, for example. In some embodiments, when an effect is reused, some points deducted from the user who triggers the reuse will be rewarded to the user who triggers the generation of the effect. The present disclosure may motivate users to aggressively create effects.

In some embodiments, when ML DB 316 searches for external data to understand a prompt/topic, higher weight will be given to external data that is more relevant to the live stream. For example, external data of the distributor may be given a higher weight than other irrelevant data. For example, when the prompt is “do the dance again”, and ML DB 316 finds external data indicating that the distributor just attended a dancing contest lately, the matching condition would be determined to be the dancing of the distributor.

In some embodiments, the effect generation condition and/or the effect reuse condition may be dynamically determined/adjusted by ML DB 316, according to the complexity of the topic/prompt, or according to the needed computing power to generate/reuse the effect. For example, if ML DB 316 determines that a prompt is complicated and the computing power to generate a corresponding effect is greater, ML DB 316 may dynamically adjust the generation condition to be tighter.

In some embodiments, a user may determine a content (such as comment or a content in the live stream) first and then choose to generate effects from the content. ML DB 316 may evaluate the complexity of the prompt and determine the payment/gift value to generate the effect according to the complexity. An UI may be displayed to the user to ask if the user accepts the cost of generating the effect.

The present techniques will be better understood with reference to the following enumerated embodiments:
A1. A method for live streaming, executed by a server, including:
obtaining a gift signal sent from a first viewer in a live stream room; and
displaying a gift effect corresponding to the gift signal to the first viewer and a distributor of the live stream room in the live stream room,
wherein the gift effect is invisible to other viewers or distributors in the live stream room.
A2. The method according to embodiment A1, further including:
obtaining a feedback signal sent from the distributor and with respect to the gift effect; and
displaying a feedback effect corresponding to the feedback signal to the first viewer and the distributor in the live stream room,
wherein the feedback effect is invisible to other viewers in the live stream room.
A3. The method according to embodiment A2, wherein the feedback effect includes an exclusive live video of the distributor.
A4. The method according to embodiment A2, wherein the feedback signal is sent from the distributor by a selection on the gift effect in the live stream room.
A5. The method according to embodiment A3, further including:
displaying a notification indicating an existence of the exclusive live video to other viewers during displaying the feedback effect to the first viewer and the distributor.
A6. The method according to embodiment A5, further including:
obtaining a selection signal with respect to the notification, from a second viewer in the live stream room; and
initiating a gifting process for the second viewer.
A7. The method according to embodiment A1, wherein
the live stream room includes multiple distributors,
the gift signal is sent from the first viewer with respect to the distributor, and
the gift effect is invisible to other viewers and distributors in the live stream room.
A8. The method according to embodiment A1, wherein the gift effect is associated with a payment of the first viewer and a reward of the distributor.
A9. The method according to embodiment A1, further including:
displaying a notification indicating an existence of the gift effect to other viewers during displaying the gift effect to the first viewer and the distributor.
A10. The method according to embodiment A1, further including:
displaying a preview of the gift effect to the distributor; and
obtaining a selection result with respect to the preview from the distributor,
wherein the selection result causes the gift effect to be invisible to other viewers in the live stream room.
A11. A method for live streaming, executed by a server, including:
obtaining a gift signal sent from a viewer to a distributor in a live stream room;
displaying a preview of a gift effect corresponding to the gift signal to the distributor;
obtaining a selection result with respect to the preview from the distributor; and
determining whether or not to display the gift effect to other viewers in the live stream room according to the selection result.
A12. A system for live streaming, including one or a plurality of processors, wherein the one or plurality of processors execute a machine-readable instruction to perform:
obtaining a gift signal sent from a first viewer in a live stream room; and
displaying a gift effect corresponding to the gift signal to the first viewer and a distributor of the live stream room in the live stream room,
wherein the gift effect is invisible to other viewers or distributors in the live stream room.
B1. A method for live streaming, executed by a server, including:
determining a topic in a live stream to have met a generation condition;
inputting the topic as a prompt into a generative AI model to generate an effect; and
displaying the effect in the live stream.
B2. The method according to embodiment B1, wherein the determining the topic in the live stream to have met the generation condition includes:
determining the topic to be associated with a number of users in the live stream; and
determining the number to be greater than a threshold.
B3. The method according to embodiment B1, wherein the determining the topic in the live stream to have met the generation condition includes:
determining the topic to be associated with a user having a user level greater than a level threshold.
B4. The method according to embodiment B1, wherein the determining the topic in the live stream to have met the generation condition includes:
determining the topic to be associated with a user who has gifted a value greater than a value threshold.
B5. The method according to embodiment B1, further including:
determining the effect to have caused good feedback in the live stream; and
saving the effect to be corresponding to the topic.
B6. The method according to embodiment B5, further including:
determining the topic to have met a reuse condition; and
displaying the effect in the live stream after determining the topic to have met the reuse condition,
wherein the reuse condition is looser than the generation condition.
B7. The method according to embodiment B5, wherein a saved correspondence between the effect and the topic extends to another live stream.
B8. The method according to embodiment B1, wherein the effect includes a matching condition associated with the topic, the method further including:
determining a distributor of the live stream to have met the matching condition; and
providing a reward to the distributor.
B9. The method according to embodiment B8, wherein the matching condition is determined by the generative AI model by searching for the topic on Internet.
B10. A system for live streaming, including one or a plurality of processors, wherein the one or plurality of processors execute a machine-readable instruction to perform:
determining a topic in a live stream to have met a generation condition;
inputting the topic as a prompt into a generative AI model to generate an effect; and
displaying the effect in the live stream.
B11. A non-transitory computer-readable medium including a program for live streaming wherein the program causes one or a plurality of computers to execute:
determining a topic in a live stream to have met a generation condition;
inputting the topic as a prompt into a generative AI model to generate an effect; and
displaying the effect in the live stream.

What is claimed is:

1. A method for streaming, executed by a server, comprising:
obtaining first interaction data of a first live stream room; and
dynamically determining a first size of a first thumbnail of the first live stream room according to the first interaction data; and
displaying the first thumbnail on a recommendation page in accordance with the first size.

2. The method according to claim 1, further comprising:
obtaining second interaction data of a second live stream room; and
dynamically determining a second size of a second thumbnail of the second live stream room according to the second interaction data; and
displaying the second thumbnail on the recommendation page in accordance with the second size,
wherein the first size is different from the second size.

3. The method according to claim 1, further comprising:
displaying a notification in the first live stream room to notify about the first size of the first thumbnail.

4. The method according to claim 1, further comprising:
obtaining a signal from a viewer in the first live stream room; and
adjusting the first size according to the signal.

5. The method according to claim 1, wherein the first interaction data includes comment data, gift data, viewer number data, or viewer retention data in the first live stream room.

6. The method according to claim 1, wherein the first size of the first thumbnail displayed on the recommendation page changes in a real time manner according to the real time variation of the first interaction data of the first live stream room.

7. The method according to claim 1, further comprising:
obtaining first attribute data of a first viewer,
wherein the first size is further determined by the first attribute data, and the recommendation page is displayed on a user terminal of the first viewer.

8. The method according to claim 7, further comprising:
obtaining second attribute data of a second viewer,
dynamically determining a third size of a third thumbnail of the first live stream room according to the first interaction data and the second attribute data, and
displaying the third thumbnail on a recommendation page shown on a user terminal of the second viewer in accordance with the third size.

9. A system for streaming, comprising one or a plurality of processors, wherein the one or plurality of processors execute a machine-readable instruction to perform:
obtaining first interaction data of a first live stream room; and
dynamically determining a first size of a first thumbnail of the first live stream room according to the first interaction data; and
displaying the first thumbnail on a recommendation page in accordance with the first size.

10. A non-transitory computer-readable medium including a program for streaming, wherein the program causes one or a plurality of computers to execute:
obtaining first interaction data of a first live stream room; and
dynamically determining a first size of a first thumbnail of the first live stream room according to the first interaction data; and
displaying the first thumbnail on a recommendation page in accordance with the first size.
